(19) United States
(12) Patent Application Publication
(10) Pub. No.: US 2025/0121671 A1
(43) Pub. Date: Apr. 17, 2025

(54) Drive Train for a Vehicle and Vehicle Comprising Same

(71) Applicant: ZF Friedrichshafen AG, Friedrichshafen (DE)

(72) Inventors: Fabian Kutter, Kressbronn (DE); Matthias Horn, Tettnang (DE); Stefan Beck, Eriskirch (DE); Johannes Kaltenbach, Friedrichshafen (DE); Thomas Martin, Weissensberg (DE); Michael Wechs, Weißensberg (DE); Uwe Griesmeier, Markdorf (DE)

(21) Appl. No.: 18/681,991

(22) PCT Filed: Jul. 7, 2022
(86) PCT No.: PCT/EP2022/068906

§ 371 Date: Feb. 7, 2024

(30) Foreign Application Priority Data
Aug. 9, 2021 (DE) 10 2021 208 644.6

(51) Int. Cl. B60K 6/40; B60K 6/24; B60K 6/26; B60K 6/36

(52) U.S. Cl. CPC B60K 6/40; B60K 6/24; B60K 6/26; B60K 6/36; B60Y 2200/92

(57) ABSTRACT

A drive train for a vehicle includes an internal combustion engine (VM) coaxial to the first axis (A1), at least one first electric machine (EM1) and one second electric machine (EM2), and a transmission arrangement (G) connectable to an output (Ab). The first electric machine (EM1) has larger dimensions than the second electric machine (EM2). The second electric machine (EM2) is connectable at least to the internal combustion engine (VM), and the first electric machine (EM1) is connectable at least to the transmission arrangement (G). The first electric machine (EM1) and the second electric machine (EM2) are coaxial to the first axis (A1). The first electric machine (EM1) and the second electric machine (EM2) are radially nested, or the first electric machine (EM1), when viewed axially, is associated with the internal combustion engine and the second electric machine (2), when viewed axially, is associated with the output.

### CROSS-REFERENCE TO RELATED APPLICATIONS

The present application is a U.S. national phase of PCT/EP2022/068906filed on Jul. 7, 2022 and is related and has right of priority to German Patent Application No. DE102021208644.6 filed on Aug. 9, 2021, both of which are incorporated by reference in their entireties for all purposes.

### TECHNICAL FIELD

The present invention relates generally to a drive train for a vehicle. The invention further relates generally to a vehicle which includes the drive train.

### BACKGROUND

Drive trains for vehicles which include an internal combustion engine and two electric machines are known from the field of vehicle technology. Furthermore, a multi-stage transmission arrangement is provided, the multi-stage transmission arrangement being connected to an output. The electric machines, when viewed axially, are arranged in succession after the internal combustion engine and a torsion damper. A superposition gear set is located between the electric machines. One of the electric machines has considerably smaller dimensions and a considerably smaller outer diameter and acts as a starter generator for the internal combustion engine, whereas the other electric machine has considerably larger dimensions and acts as a vehicle drive.

It has been shown that electric machines which act as a vehicle drive require a large amount of installation space, since these machines require considerable dimensions with respect to outer diameter and axial length. Consequently, the electric machines acting as a vehicle drive are to be arranged as close as possible to the internal combustion engine, since this is where the greatest amount of installation space is available. A coaxial arrangement of the electric machines axially next to each other is considerably limited due to the insufficient amount of available installation space.

### BRIEF SUMMARY

Example aspects of the present invention provide a drive train and a vehicle of the aforementioned type, in which the electric machines are arranged in a manner that is as favorable as possible with respect to installation space.

According to example aspects of the present invention, a drive train for a vehicle with an internal combustion engine is provided, the internal combustion engine being coaxial to a first axis. Furthermore, the drive train includes at least one first electric machine and one second electric machine, and a multi-stage transmission arrangement which is connectable to an output. The first electric machine has larger dimensions than the second electric machine, wherein the second electric machine is connectable at least to the internal combustion engine and the first electric machine is connectable at least to the transmission arrangement, and wherein the first electric machine and the second electric machine are coaxial to the first axis. In order to provide an arrangement that is as favorable as possible with respect to installation space, the first electric machine and the second electric machine are radially nested with respect to each other.

In the drive train according to example aspects of the invention, despite the coaxial arrangement of the two electric machines with respect to the first axis, the two electric machines can be arranged as close as possible to the internal combustion engine in a particularly installation-space-saving manner, since the two electric machines are nested radially within each other.

With respect to the drive train according to example aspects of the invention, it is advantageous when the second electric machine, which has the smaller dimensions, is arranged radially within the first electric machine, which has the larger dimensions. It is particularly advantageous when the first electric machine is designed as an external-rotor machine.

Due to the radial arrangement of the two electric machines according to example aspects of the invention, the available radial installation space can be optimally utilized, for example, in a vehicle having a front longitudinal installation position of the prime mover, for example, in the vehicle tunnel, due to the installation-space-saving arrangement of the electric machines.

According to example aspects of the invention, a drive train for a vehicle is provided, the drive train having an internal combustion engine which is coaxial to a first axis, having at least one first electric machine and one second electric machine and having a multi-stage transmission arrangement, the multi-stage transmission arrangement being connectable to an output. The first electric machine has larger dimensions than the second electric machine, wherein the second electric machine is connectable at least to the internal combustion engine and the first electric machine is connectable at least to the transmission arrangement, and wherein the first electric machine and the second electric machine are coaxial to the first axis. In the drive train, an arrangement of the electric machines that is as favorable as possible with respect to installation space is achieved when the first electric machine, when viewed axially, is associated with or faces the internal combustion engine and the second electric machine, when viewed axially, is associated with or faces the output.

In an alternative example approach, the first electric machine, which has the larger dimensions, is located as close as possible to the internal combustion engine or is arranged adjacently thereto, in order to therefore optimally utilize the available radial installation space exclusively for the first electric machine, for example, in a vehicle having a front longitudinal installation position of the prime mover, for example, in the vehicle tunnel. The second electric machine, which has the smaller dimensions, is located as close as possible to the output and, therefore, is adjacent thereto. In this way, the installation space available there can be utilized for the smaller second electric machine. The installation space available for the first machine at the internal combustion engine is therefore increased.

Consequently, the first electric machine, when viewed axially, can be advantageously arranged ahead of the transmission arrangement and the second electric machine, when viewed axially, can be advantageously arranged behind the transmission arrangement. In order to connect the second electric machine to the internal combustion engine in the structurally simplest manner possible, it can also be provided that a fourth shaft, which is coaxial to the first axis, is guided axially through the transmission arrangement.

The first electric machine, which is provided axially ahead of the transmission arrangement, is connectable to the transmission arrangement via a transmission input shaft. The transmission arrangement is connectable to the output via a gear stage or the like, preferably via a spur gear stage. The gear stage, when viewed axially, is arranged between the transmission arrangement and the second electric machine. Other connections between the transmission arrangement and the output are also conceivable, the connections establishing a connection of the transmission output shaft to the output between the transmission output and the second electric machine, when viewed axially.

In the alternative example approach, the output can be associated with a second axis, wherein the second axis is axially offset with respect to the first axis such that the second axis is arranged radially outside the second electric machine. In this way, the radial installation space, which is available radially outwards due to the smaller outer diameter of the second electric machine, can be advantageously utilized for the output.

Regardless of the above-described subjects, various types of transmissions with respect to the transmission arrangement can be used in the drive train according to example aspects of the invention. For example, a planetary transmission, a countershaft transmission, or even a combination thereof can be used.

Furthermore, in the drive train according to example aspects of the invention, the first electric machine, which has the larger dimensions and has a larger outer diameter, is to be preferably provided as a vehicle drive, since this first electric machine can apply greater power. In the drive train according to example aspects of the invention, the second electric machine has smaller dimensions than the first electric machine and, therefore, is preferably used as a starter generator, i.e., for starting the internal combustion engine, or as a generator. It is possible, however, that the second electric machine is used during the driving operation for increasing power in certain driving situations.

In order to achieve a purely electric driving operation with the drive train according to example aspects of the invention, in which at least the first electric machine or also the second electric machine can be used, it is provided that the internal combustion engine is decouplable from the drive train via a shift element, for example, a clutch.

The drive train according to example aspects of the invention can optionally include an all-wheel transfer gearbox which is connected downstream from the output, in order to realize all-wheel drive in the vehicle.

According to example embodiments, a vehicle may include the above-described drive train which is oriented in the vehicle longitudinal direction, such that the above-described advantages and further advantages result. A front longitudinal installation position of the internal combustion engine is therefore realized in the vehicle according to example aspects of the invention.

### BRIEF DESCRIPTION OF THE DRAWINGS

Example aspects of the present invention are explained in greater detail in the following with reference to the drawings, wherein:

FIG. 1 shows a schematic view of a first example embodiment of a drive train according to example aspects of the invention having radially nested electric machines; and

FIG. 2 shows a schematic view of a second example embodiment of a drive train according to example aspects of the invention having a first electric machine, which is arranged close to the drive, and a second electric machine, which is arranged close to the output.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

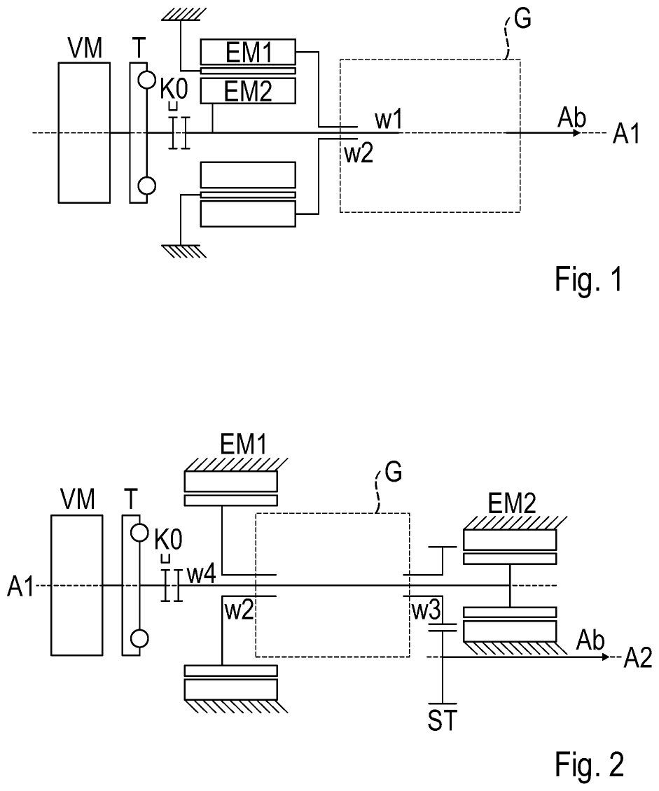

FIGS. 1 and 2 show two various example embodiments of a drive train according to example aspects of the invention in a vehicle merely by way of example.

With respect to the described connections between transmission components, the term “connectable” is used, which claims both a separable connection and a permanent connection. Moreover, the selected term also claims a direct connection or an indirect connection established via further components.

Regardless of the two example embodiments, it is provided with respect to the drive train according to example aspects of the invention that an internal combustion engine VM is coaxial to a first axis A1, which corresponds to the crankshaft axis of the internal combustion engine VM in the figures. Furthermore, a first electric machine EM1 and a second electric machine EM2 are provided, wherein the first electric machine EM1 has larger dimensions than the second electric machine EM2. This means, the first electric machine EM1 has higher power and therefore a larger outer diameter than the second electric machine EM2. Consequently, the first electric machine EM1 is preferably or exclusively used for the vehicle drive and the second electric machine EM2 is preferably or exclusively used to start the internal combustion engine VM and/or as a generator. Therefore, the second electric machine EM2 is connectable at least to the internal combustion engine VM and the first electric machine EM1 is connectable at least to the transmission arrangement G. Furthermore, it is provided that the first electric machine EM1 and the second electric machine EM2 are both coaxial to the first axis A1. A shiftable multi-stage transmission, for example, which is connectable to an output Ab, is provided as the transmission arrangement G.

Within the framework of the first example embodiment according to FIG. 1, in order to provide an arrangement of the electric machines EM1, EM2 that is as favorable as possible with respect to installation space, the first electric machine EM1 and the second electric machine EM2 are radially nested. The radial nesting ensures that the second electric machine EM2 is arranged radially within the first electric machine EM1. This is equivalent to the first electric machine EM1 being arranged radially outside the second electric machine.

Furthermore, it is apparent from FIG. 1 that the transmission arrangement G, when viewed axially, is arranged behind the first electric machine EM1 and the second electric machine EM2. In addition, in the first example embodiment, the output Ab is coaxial to the first axis A1 and to the crankshaft axis.

In addition, it is provided according to FIG. 1 that the second electric machine EM2 is connectable to the transmission arrangement G and the internal combustion engine VM via a, for example, first, transmission input shaft W1, which is coaxial to the first axis A1, and that the first electric machine EM1 is connectable to the transmission arrangement G via a further, for example, second, transmission input shaft W2, which is also coaxial to the first axis A1.

Within the framework of the second example embodiment according to FIG. 2, an alternative approach for an arrangement of the electric machines EM1, EM2 that is as favorable as possible with respect to installation space is shown, in which the first electric machine EM1, when viewed axially, is associated with the internal combustion engine and the second electric machine EM2, when viewed axially, is associated with the output. The first electric machine EM1, when viewed axially, is arranged ahead of the transmission arrangement G and the second electric machine EM2, when viewed axially, is arranged behind the transmission arrangement.

Furthermore, it is apparent from FIG. 2 that the second electric machine EM2 is connectable to the internal combustion engine VM via a first shaft W1, wherein the first shaft W1 is axially guided through the transmission arrangement G and is coaxial to the first axis A1.

In addition, it is provided in the second example embodiment that the first electric machine EM1 is connectable to the transmission arrangement G via a transmission input shaft W2 and that the transmission arrangement G is connectable to the output Ab via a gear stage, preferably a spur gear stage ST. The spur gear stage ST, when viewed axially, is arranged between the transmission arrangement G and the second electric machine EM2.

In the second example embodiment shown in FIG. 2, the output Ab is associated with a second axis A2, wherein the second axis A2 is axially offset with respect to the first axis A1 such that the second axis A2 is arranged radially outside the second electric machine EM2 in an installation-space-saving manner.

In the two example embodiments according to FIGS. 1 and 2, it is shown by way of example that a torsional vibration damper T is connected downstream from the internal combustion engine VM, the torsional vibration damper T being connectable via a shift element K0 to the first shaft W1, which is coaxially associated with the first axis A1.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

EM1 first, larger-dimensioned, electric machine
EM2 second, smaller-dimensioned, electric machine
VM internal combustion engine
A1 first axis or crankshaft axis
A2 second axis, axially offset with respect to the first axis
Ab output
G multi-stage transmission arrangement
W1 transmission input shaft, which is coaxial to the first axis
W2 further transmission input shaft, which is coaxial to the first axis
W3 transmission output shaft
W4 fourth shaft, which is coaxial to the first axis
ST gear stage or spur gear stage
K0 clutch
T torsional vibration damper

1-16.(canceled)

17. A drive train for a vehicle, comprising:
an internal combustion engine (VM) arranged coaxial to a first axis (A1);
a transmission arrangement (G) connectable to an output (Ab);
a first electric machine (EM1) connectable at least to the transmission arrangement (G);
a second electric machine (EM2) connectable at least to the internal combustion engine (VM);
wherein the first electric machine (EM1) has larger dimensions than the second electric machine (EM2),
wherein the first electric machine (EM1) and the second electric machine (EM2) are arranged coaxial to the first axis (A1), and
wherein the first electric machine (EM1) and the second electric machine (EM2) are radially nested.

18. The drive train of claim 17, wherein the second electric machine (EM2) is arranged radially within the first electric machine (EM1).

19. The drive train of claim 17, wherein:
the second electric machine (EM2) is connectable to the transmission arrangement (G) and the internal combustion engine (VM) via a transmission input shaft (W1) that is arranged coaxial to the first axis (A1), and
the first electric machine (EM1) is connectable to the transmission arrangement (G) via a further transmission input shaft (W2).

20. The drive train of claim 17, wherein the transmission arrangement (G) is arranged axially behind the first electric machine (EM1) and the second electric machine (EM2).

21. The drive train of claim 17, wherein the output (Ab) is arranged coaxial to the first axis (A1).

22. The drive train of claim 17, wherein the transmission arrangement (G) comprises one or both of a planetary transmission and a countershaft transmission.

23. The drive train of claim 17, wherein the first electric machine (EM1) is configured as a vehicle drive, and the second electric machine (EM2) is configured for starting the internal combustion engine (VM) and/or as a generator.

24. The drive train of claim 17, further comprising a torsional vibration damper (T) connected downstream from the internal combustion engine (VM).

25. The drive train of claim 17, further comprising a shift element (K0), the internal combustion engine (VM) decouplable via the shift element (K0) from a first shaft (W1) that is arranged coaxial to the first axis (A1).

26. The drive train of claim 17, wherein further comprising an all-wheel transfer gearbox connected downstream from the output (Ab) of the transmission arrangement.

27. A vehicle, comprising the drive train of claim 17, wherein the drive train is oriented in a longitudinal direction of the vehicle.

28. A drive train for a vehicle, comprising:
an internal combustion engine (VM) arranged coaxial to a first axis (A1);
a transmission arrangement (G) connectable to an output (Ab),
a first electric machine (EM1) connectable at least to the transmission arrangement (G); and
a second electric machine (EM2) connectable at least to the internal combustion engine (VM),
wherein the first electric machine (EM1) has larger dimensions than the second electric machine (EM2),
wherein the first electric machine (EM1) and the second electric machine (EM2) are arranged coaxial to the first axis (A1),
wherein the first electric machine (EM1) is disposed axially towards the internal combustion engine, and the second electric machine (2) is disposed axially towards the output (Ab).

29. The drive train of claim 28, wherein the first electric machine (EM1) is arranged axially forward of the transmission arrangement (G), and the second electric machine (EM2) is arranged axially behind the transmission arrangement (G).

30. The drive train of claim 28, wherein the second electric machine (EM2) is connectable to the internal combustion engine (VM) via a fourth shaft (W4), wherein the fourth shaft (W4) is axially guided through the transmission arrangement (G) and is coaxial to the first axis (A1).

31. The drive train of claim 28, wherein:
the first electric machine (EM1) is connectable to the transmission arrangement (G) via a transmission input shaft (W2);
the transmission arrangement (G) is connectable to the output (Ab) via a gear stage (ST); and
the gear stage (ST) is arranged axially between the transmission arrangement (G) and the second electric machine (EM2).

32. The drive train of claim 28, wherein the output (Ab) is arranged coaxial to a second axis (A2), and the second axis (A2) is offset with respect to the first axis (A1) such that the second axis (A2) is arranged radially outside the second electric machine (EM2).

33. The drive train of claim 28, wherein the transmission arrangement (G) comprises one or both of a planetary transmission and a countershaft transmission.

34. The drive train of claim 28, wherein the first electric machine (EM1) is configured as a vehicle drive, and the second electric machine (EM2) is configured for starting the internal combustion engine (VM) and/or as a generator.

35. The drive train of claim 28, further comprising a torsional vibration damper (T) connected downstream from the internal combustion engine (VM).

36. The drive train of claim 28, further comprising a shift element (K0), the internal combustion engine (VM) decouplable via the shift element (K0) from a first shaft (W1) that is arranged coaxial to the first axis (A1).

37. The drive train of claim 28, wherein further comprising an all-wheel transfer gearbox connected downstream from the output (Ab) of the transmission arrangement.

38. A vehicle, comprising the drive train of claim 28, wherein the drive train is oriented in a longitudinal direction of the vehicle.
